(19) United States
(12) Patent Application Publication
(10) Pub. No.: US 2013/0220486 A1
(43) Pub. Date: Aug. 29, 2013

(54) TIMBER INCISING

(71) Applicant: Peter W. Guggi, Ligist (AT)

(72) Inventor: Peter W. Guggi, Ligist (AT)

(73) Assignee: ARCH TIMBER PROTECTION LIMITED, Castleford, Yorkshire (GB)

(21) Appl. No.: 13/636,790

(22) PCT Filed: Mar. 21, 2011
(86) PCT No.: PCT/GB2011/050557

§ 371 Date: Apr. 2, 2013

(30) Foreign Application Priority Data
Mar. 22, 2010 (GB) 1004735.5

(51) Int. Cl. B27M 1/00

(52) U.S. Cl. CPC B27M 1/006
USPC 144/363; 144/24.1

(57) ABSTRACT

Apparatus for forming incisions in a timber plank, comprises: at least two rotary incisors each comprising a plurality of circumferentially distributed teeth and arranged in use to rotate at the same rate to form respective patterns of incisions in a common face of a plank as it is moved past the incisors, said patterns having a predetermined longitudinal alignment between them; depth-controlling means arranged to maintain, for each incisor, a predetermined depth of penetration of the teeth thereof into the plank; means for adjusting said predetermined depths of penetration; and means for allowing adjustment of the incisors (double-arrow) to compensate for the altered spatial period in said patterns when the depths of penetration of the incisors are adjusted, thereby allowing said longitudinal alignment between the respective patterns to be maintained.

This invention relates to apparatus and methods for incising timber using toothed, rotary incisors.

When treating wood with preservatives, such as fungicide or insecticide, it can be desirable to form a series of incisions in the surface of the wood to enable proper penetration of the preservative. This is especially true of the heartwood of spruce, fir, pine, larch, Douglas-fir, beech, oak and other hardwoods which only allows a surface treatment, without any significant depth of penetration, unless incisions are made.

U.S. Pat. No. 4,836,254 describes a multi-head incising apparatus for incising at least two sides of a piece of lumber or timber in a single pass. It has at least two sets of toothed incisor rolls, each set having an upstream roll and a downstream roll, spaced apart in one plane. Each of these rolls makes a pattern of incisions in the lumber or timber, and the apparatus has means to synchronize rotation of the two rolls in each set to ensure the patterns combine to a predetermined final pattern of closely spaced apart incisions. One reason for using two rolls in each plane is that annular cleaning rings or combs with cleaning teeth between incisor discs impose a minimum spacing between adjacent incisors discs; however, superimposing two patterns from respective rolls enables a final pattern having more-closely spaced incisions than is achievable with just a single roll.

In a main embodiment of U.S. Pat. No. 4,836,254, the two rolls in each set have respective sprockets, and a chain connects these sprockets together so that the two rolls turn at the same rate.

The present applicant has come to realise that the apparatus of U.S. Pat. No. 4,836,254 has a significant shortcoming: namely that, in order to apply the predetermined incision pattern accurately, the timber must always be incised to a constant incision depth, determined by the design of the apparatus. However, different combinations of wood type, size and preservative composition have different optimal incision depths; for example, it may desirable to incise some wood to a depth of 3 mm and other wood to a depth of 8 mm, 15 mm, 25 mm or any depth in between. It is therefore desirable to have an apparatus that can be readily adapted to incise to different depths.

The present invention seeks to overcome this shortcoming.

Thus, from a first aspect, the invention provides apparatus for forming incisions in a timber plank, comprising:
at least two rotary incisors each comprising a plurality of circumferentially distributed teeth and arranged in use to rotate at the same rate to form respective patterns of incisions in a common face of a plank as it is moved past the incisors, said patterns having a predetermined longitudinal alignment between them;
depth-controlling means arranged to maintain, for each incisor, a predetermined depth of penetration of the teeth thereof into the plank;
means for adjusting said predetermined depths of penetration; and
means for allowing adjustment of the incisors to compensate for the altered spatial period in said patterns when the depths of penetration of the incisors are adjusted, thereby allowing said longitudinal alignment between the respective patterns to be maintained.

The skilled person will appreciate that such apparatus can be conveniently adjusted to alter the depth of incisions formed in the plank without losing synchronisation between the patterns formed by the respective incisors. In this way, the patterns superimpose to give the same desired formation of interleaved incisions regardless of the determined incision depths.

The incision depth of one or both incisors can be adjusted and compensation can be applied to ensure that a desired synchronisation, or longitudinal alignment, of the incision patterns from each incisor is maintained. This is not possible with the apparatus of the prior art, which does not provide depth-adjusting means, nor means to compensate for the effects of any depth adjustment, were such adjustment possible.

As used herein the spatial period is defined as the length of the pattern formed by one complete revolution of an incisor; i.e. it is the effective circumference of the rotary incisor at the surface of the plank face. In order to maintain a particular alignment between the patterns, this period will need to be the same for both incisors. The axes of both incisors should therefore be at the same distance from the surface of the plank.

In preferred embodiments the same regular pattern of teeth is provided on each incisor. In such embodiments the longitudinal alignment between the patterns is easy to observe and the longitudinal offset between any pair of respective incisions from the two patterns could be used to define it. Clearly the number of teeth on the incisors and hence the spacing distance between the incisions will determine the maximum possible offset distance.

However it is not essential for the patterns on the incisors to be the same or even for either of them to be regular. More generally therefore each of the patterns can be treated as having a longitudinal spatial repetition period which is either equal to, or is an integer fraction of, the spatial period (depending on how the teeth are arranged around the incisor). The lowest common multiple of the two minimum repetition periods of the two incisors defines a spatial repetition period of the combined pattern. The longitudinal alignment may then conveniently be defined as the longitudinal distance between the mid-points of two reference incisions, one from each pattern, divided by the combined spatial repetition period. The reference incisions may be arbitrarily chosen but only occur once in every repetition period of the combined pattern.

However, other suitable definitions of the longitudinal alignment may be used instead, especially in the case where the shapes of the individual teeth are asymmetrical—e.g. saw-tooth shape.

As mentioned above, the patterns formed by the two incisors are preferably identical, but this is not essential. In particularly preferred embodiments, for each incisor the teeth at any given axial distance along the incisor are uniformly distributed around the circumference. The minimum spatial repetition period of the pattern formed by such an incisor is then simply equal to the distance between adjacent teeth at the surface of the plank.

In one set of embodiments of the present invention, the compensating means comprises means for adjusting the distance between the axes of the two rotary incisors. This preferably comprise means whereby one of the incisors can be slidably moved towards and away from the other incisor. Both incisors may be slidably movable relative to a housing or frame, but in some preferred embodiments one incisor is fixed relative to a housing or frame and the other incisor is movable. The movable incisor may be held in a given position by secure retaining means, such as a notch or a clamping nut and bolt, ratchet etc. One or both incisors may be acted on, directly or indirectly, by one or more springs.

Additionally or alternatively the means for compensating comprises means for adjusting the rotational offset of the teeth of one of the incisors relative to the teeth of the other incisor. Thus in some embodiments, the means for compensating comprises both means for adjusting the distance between the two incisors and means for adjusting the rotational offset of one of the incisors relative to the other. These means may be the same, or may share some components in common, or may be wholly distinct.

The compensating means may act automatically; that is, it may be such that adjusting the depth causes the compensating means to apply appropriate compensation without further human input. This automation may be purely mechanical, or it may involve use of one or more electronic controls, such as a computer processor.

The incisors could take the form of single discs but preferably they each comprise a plurality of coaxial, toothed incisor discs, effectively forming a roller structure. The separation distance between adjacent discs along the roller may be selected appropriately depending on the kind of wood, the treatment product, and/or the kind of process being used. It might, for example, be between 1.6 mm and 6.0 mm. The discs may be polygonal, but are (except for the teeth) preferably substantially circular or annular, forming a cylindrical roller. For each incisor, the discs are preferably fixed to an axle or shaft, for example by interfacing with splines formed along the axle, thereby enforcing a common rotation rate. The discs may be identical to one another, or may differ; in particular, they may have the same or different numbers and spacing of teeth around their circumferences. For economy of manufacturing, every incisor disc is preferably the same. However, as explained below, the teeth of each disc are not necessarily identically rotationally-aligned between adjacent discs along the axle, instead being rotationally staggered along the axle. An advantage of a roller made up of individual discs is that allows discs to be replaced separately if they become worn. It also allows the width of the roller to be altered. However in an alternative set of embodiments an integral roller having an equivalent pattern of teeth could be provided.

The depth-controlling means in some embodiments may comprises a guide, such as a roller, acting on one of the faces of the plank. In some embodiments it could control the depth relative to the face being incised, which is advantageous as the depth is then independent of any variation in the thickness of the plank. In other embodiments the depth-controlling means acts on an opposite face of the plank to the toothed incisors. In either case there is preferably provided a fixed, but adjustable, spacing between the guide and the toothed incisors. In one set of embodiments, rather than a dedicated depth guide, the depth-controlling means may comprise one or more further incisors, acting on a parallel opposed face. The incision depth on both faces for a given thickness of plank may therefore be controlled through the mutual separation of the respective sets of incisors.

Although in preferred embodiments both incisors are arranged to incise to the same depth below the surface of the plank, this is not essential and they may incise to different depths. The depths may be adjustable in unison or may be adjustable independently. Typically the incisor making the deeper incision would have longer teeth compared to the other one but the axis of rotation would be at the same height above the plank to ensure rotation at the same speed.

As mentioned above, in some preferred embodiments, the apparatus comprises further incisors arranged to form incisions on a second face of the plank; for example, on a face parallel to the first face, or perpendicular thereto. In such embodiments, the depth-controlling means may comprise means for holding the two pairs of incisors at a fixed separation distance from each other; for example by means of a variable-length strut. This separation distance is adjustable, by the means for adjusting the depth of penetration, both to cater for varying sizes of plank and to alter the depth of incision. The plank may self-centre between the opposed incisors, or may be guided, for example by guide rollers. The distance may be changed manually or the apparatus may comprise means for receiving an indication of a desired incision depth and controlling the apparatus so as to produce incisions of the indicated depth; this control may be purely mechanical or may comprise electronic circuitry; for example, a computer which receives as input a desired incision depth and a dimension of the plank (either manually entered, or measured by the apparatus) and outputs a signal to an actuator to adjust the spacing between a pair of incisors and a guide or another pair of incisors.

In a set of embodiments four pairs of incisors are provided, each pair arranged to act on a different face of a plank of rectangular cross section. The apparatus preferably comprises depth-controlling means, depth-adjusting means and compensation means in respect of every pair of incisors. In other embodiments, any number of incisors may act on any one or more faces of the plank.

Incisors arranged to act on a common surface, for example a pair of incisors, may be independently rotatable or may be linked, for example by gears or a chain.

Preferably at least one incisor of the apparatus is powered, e.g. by an electric motor, so as to propel the plank through the apparatus. However, this is not essential, and alternative propulsion means may be used such as manual pushing of the plank through the machine, or separate drive rollers or a conveyor belt. Using one of the incisors to propel the plank is advantageous in that the incising teeth provide a secure grip on the plank, which may not be so readily achievable by other means. In some embodiments, at least one incisor of every set of incisors acting on respective common faces of the plank is driven; this can provide additional power for timber species that require it, and may help facilitate a smooth passage of the plank through the apparatus, since reduced torque is applied to the plank.

All the incisors acting on a common face of the plank are preferably synchronised so that the regular patterns of incisions from each incisor interleaves those of the other incisors in a predetermined manner to yield a desired final pattern.

Synchronisation between the incisors may be achieved by in several ways. In some embodiments the apparatus comprises synchronised motors driving the respective axles of at least some of the incisors. In one set of embodiments a timing belt or chain is provided connecting between sprockets or wheels mounted on, or communicating drive to, an axle of each incisor. A single motor may then be sufficient. In some embodiments, particularly where the spacing between the incisors is variable, the apparatus further comprises a tensioning means, e.g. sprocket, roller or wheel, acting on the chain or belt to maintain a desired tension when the distance between two or more incisors is increased or decreased. The timing belt may be a toothed belt, for example.

Alternatively or additionally, tensioning means can enable the belt or chain to be slackened sufficiently that the rotational and/or lateral position of one or more of the incisors may be changed by disengaging the belt or chain from the respective incisor, rotating and/or laterally moving the incisor, and re-engaging the chain with the incisor. This may be done manually or by mechanical actuating means. Where there are more than two incisors forming mutually overlapping patterns on a single face of the plank, the incisors may be linked by a plurality of belts or chains, with a plurality of tensioners; for example, one between every adjacent pair of incisors.

In some preferred embodiments, compensation for the altered period of the pattern of incision is applied to two incisors by moving the tensioner relative to one or both incisors so as to alter the length of a section of chain or belt extending directly between the respective incisors, thereby simultaneously altering the separation distance between the incisors and the relative rotational offset between the incisors; i.e. one of the incisors is effectively rolled towards or away from the other, rather than being translated purely laterally, or being rotated in place, which are alternative adjustment mechanisms. In such embodiments, one or both incisors may be movable, and may be biased away from the other incisor of the pair by spring means. Alternatively, one or both incisors may be releasably fixed in position and can be released when an adjustment is being made, and secured in position subsequently.

As explained above, by the use of a tensioning means such as a sprocket, the spacing between the incisors and/or the relative rotational angles of the incisors may be easily adjusted. The tensioner may be temporarily locked in position, for example by frictional retention with a nut and bolt acting on a slotted frame member, or it may be tensioned by resilient means, acting against tension in the chain.

Where a timing belt or chain is used, advantageously only one incisor of the pair need be directly driven, e.g. by a motor; the other can be driven indirectly by the timing chain.

Any sprocket or wheel associated with a incisor need not necessarily be coaxial with the incisor, but could be operably connected to it by any number of intermediate gears, shafts, etc.

Where incisors act on multiple faces of the plank, these may all be synchronised, or synchronisation may be effected for each face independently.

In other embodiments, the incisors are each directly driven, e.g. by respective electric motors, with the apparatus comprising means to ensure that the rotation of the drive incisors is synchronised at the same rate as each other. This may be accomplished for example by an incremental position encoder and a servo-motor. By setting a starting position (feather key), the incisors can be positioned in relation to each other in such a way that the incisors create a desired interleaved pattern. Servo-motor positioning may be accomplished manually or by automatic positioning means which receives an input of a desired perforation depth and controls the servomotor accordingly.

The teeth of the incisors may be of any suitable shape, such as pointed, rounded or spiked. Preferably they are each symmetrical about a central radial line. In a set of preferred embodiments the teeth are three-sided, preferably tapering in width towards their distal edges—e.g. presenting a truncated triangular shape.

The teeth are preferably substantially laminar although this will typically include some tapering in thickness towards their tips. Preferably such thickness taper is not to a knife-edge. This serves to reduce stress in the timber compared with a sharp edge, by primarily compressing the wood inwards rather than separating the fibres. This reduces the tendency for the timber to expand against the tooth as it is pulled out, which would otherwise result in tearing of the wood. It also avoids surface cambers forming between adjacent incisions. However, this is not essential, and apparatus of the invention may use sharp edges.

The described essentially laminar, truncated triangular teeth will create slot-like incisions in the wood, the length of which is dependent on the chosen depth of penetration.

A single incisor disc may carry any number of teeth. The preferred number is generally dependent on the diameter of the incisors and the depth of incision. The number of teeth might, for example, be between 1 and 100, possibly 20 to 30. In one set of embodiments every disc has 24 teeth.

The apparatus preferably has a mechanism for removing debris from the incisor discs and/or for preventing ripping of the timber surface. Such a mechanism may comprise floating rings mounted between adjacent incisor discs along the incisor axis, or combing or tooth-pick devices, hold-down bars, pressure plates, or a combination of these. In one set of embodiments, the apparatus comprises a guide having one or more through slots arranged such that the slots are aligned with respective incisor discs so as to form pressure plates between adjacent discs. These pressure plates can apply a force to the wood in a direction so as to resist ripping or splintering of the surface of the wood. The guide may comprise a cylinder through which the plank passes during the incising.

In some embodiments, the apparatus comprises means for lubricating the plank as it passes through the apparatus. This preferably comprises a nozzle for spraying a liquid lubricant or wetting agent onto some or all of the plank. The lubricant is preferably water or a preservative, such as a suitably-diluted sap-stain product. It may be applied by means of a spray, water curtain, brushes, rollers or other suitable wetting devices.

When viewed from second aspect, the invention provides a method of operating a machine for forming incisions in a timber plank, comprising:
using at least two rotary incisors each comprising a plurality of circumferentially distributed teeth and rotating at the same rate to form respective patterns of incisions at a first incision depth in a common face of the plank as it is moved past the incisors, said patterns having a predetermined longitudinal alignment between them;
adjusting said machine to form said respective patterns of incisions at a second, different incision depth; and
adjusting said incisors to compensate for the altered spatial period in said patterns, thereby maintaining said longitudinal alignment between the respective patterns.

Adjusting said incisors to compensate for the altered spatial period in said patterns may comprise moving one of the incisors of the pair towards or away from the other incisor. Such moving may involve directly moving the incisor, or may involve moving a tensioning wheel which acts on a belt or chain connected to the incisor so as to move the incisor.

Alternatively or additionally, the adjusting step may comprise changing the rotational position of one or the incisors relative to the other incisor. This may comprise adjusting a control connected to a servo-motor, or it may comprise changing the position of the teeth of the incisor relative to a chain or belt; for example by disengaging the chain or belt from a sprocket or wheel connected to the incisor, changing the rotational position of the incisor, and re-engaging the chain or belt; or by disengaging a sprocket, shaft or axle from another part of the incisor, adjusting the relative rotational position of the incisor, and re-engaging the sprocket, shaft or axle.

From a further aspect, the invention provides an apparatus for forming incisions in a timber plank, comprising:
a frame;
first and second rotary incisors mounted on respective axles held by said frame, each incisor comprising a plurality of circumferentially distributed teeth and arranged in use to form respective patterns of incisions in a common face of a plank as it is moved past the incisors;
depth-controlling means arranged to maintain, for each incisor, a predetermined depth of penetration of the teeth thereof into the plank; and
means for adjusting said predetermined depths of penetration, wherein the frame defines a plurality of positions at which the axle of the second incisor may be held, each position corresponding to a different separation distance between the second axle and first axle.

From a further aspect, the invention extends to use of apparatus as described herein for incising a timber plank.

Although the invention has been described with reference to timber planks, the skilled person will appreciate that apparatus of the invention could be used to incise materials other than wood, or boards made from processed wood such as chipboard, plywood, medium-density fibreboard, veneers, etc. Suitable modifications, within the grasp of the skilled person, may be made to the apparatus to enable such uses. The apparatus may be adapted to incise wood that is not in the form of a finished plank, but is in an irregular shape or, for example, still carries bark on at least one surface. The term plank is not to be understood as limited to any particular shape of wood; rather, it is intended to encompass any board or other cut piece of wood. Timber and lumber are both used herein to refer to wood from a felled tree.

Although the description has referred primarily to two rotary incisors acting on a given face, any greater number could be provided.

Features described herein with reference to one embodiment or aspect of the invention may, where appropriate, be used with any other embodiment or aspect.

Certain preferred embodiments of the invention will now be described, by way of example only, with reference to the accompanying drawings, in which:

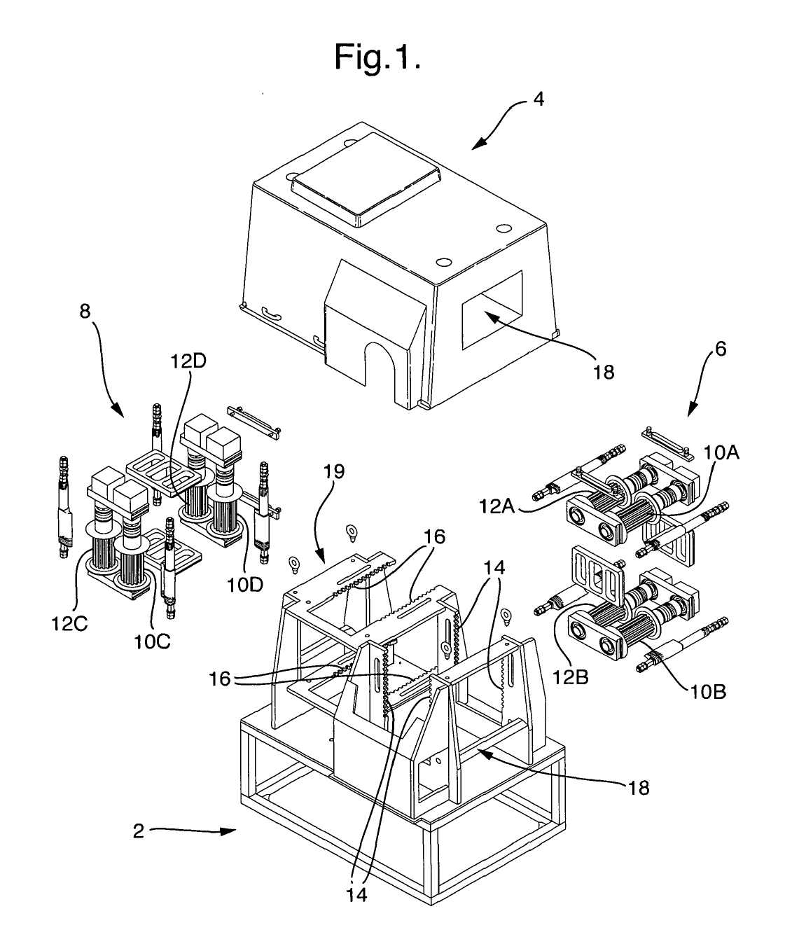

FIG. 1 is an exploded isometric drawing of the primary components of an apparatus embodying the invention;

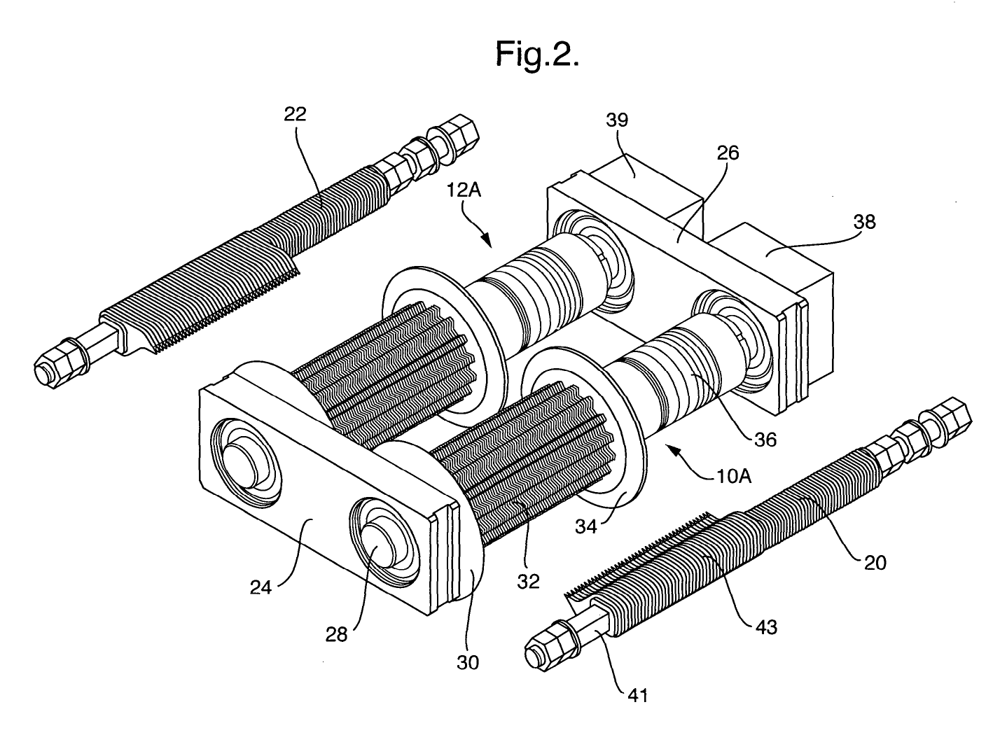

FIG. 2 is an exploded isometric drawing of an upper pair of rollers of the apparatus;

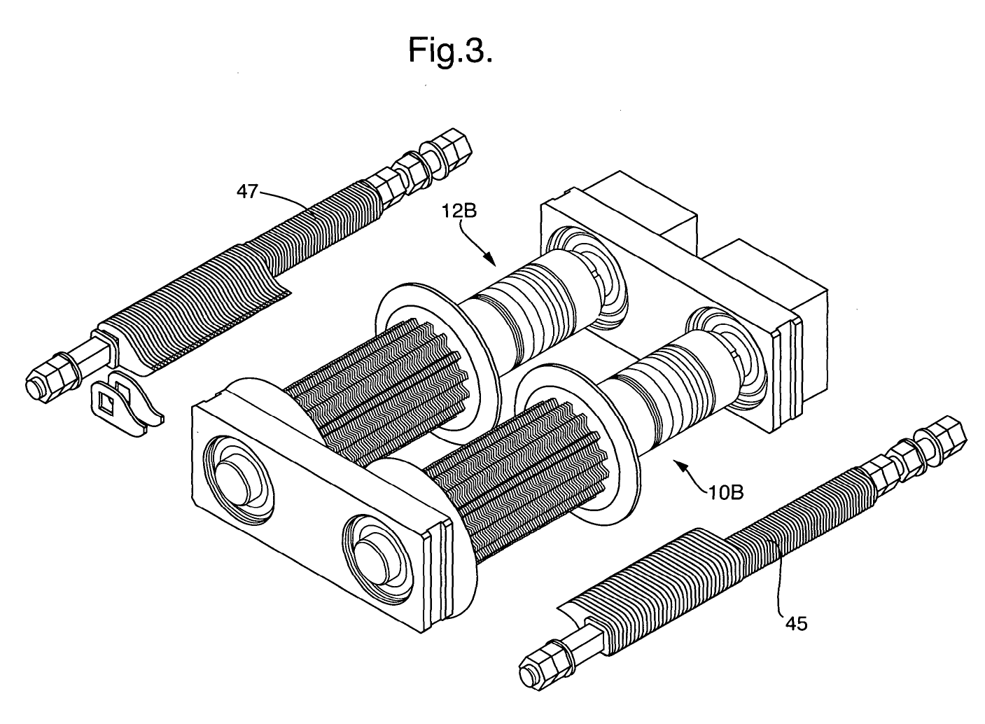

FIG. 3 is an exploded isometric drawing of a lower pair of rollers of the apparatus;

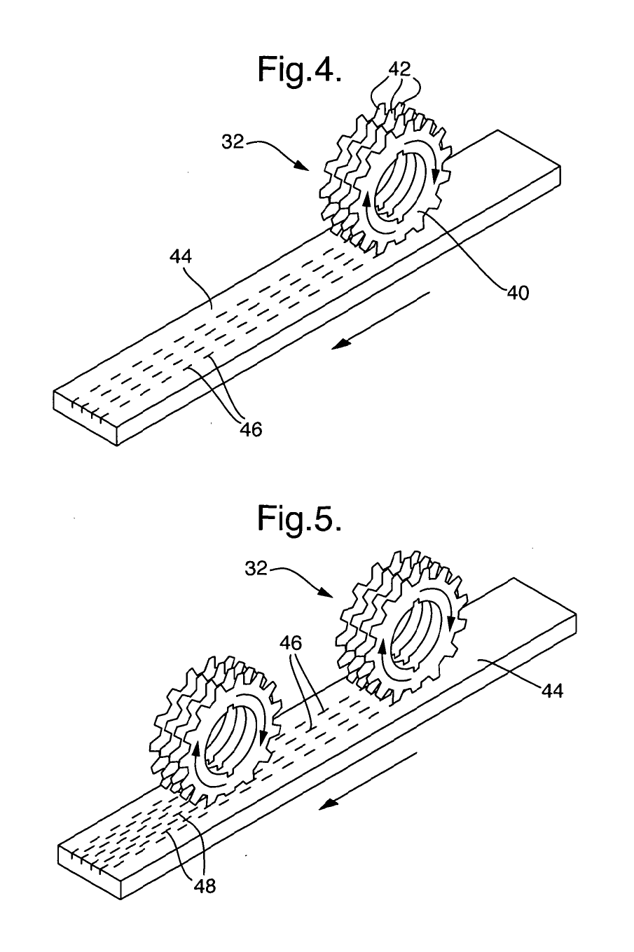

FIG. 4 is an isometric view of a single set of incisor discs incising a plank;

FIG. 5 is an isometric view of two sets of incisor discs incising a plank;

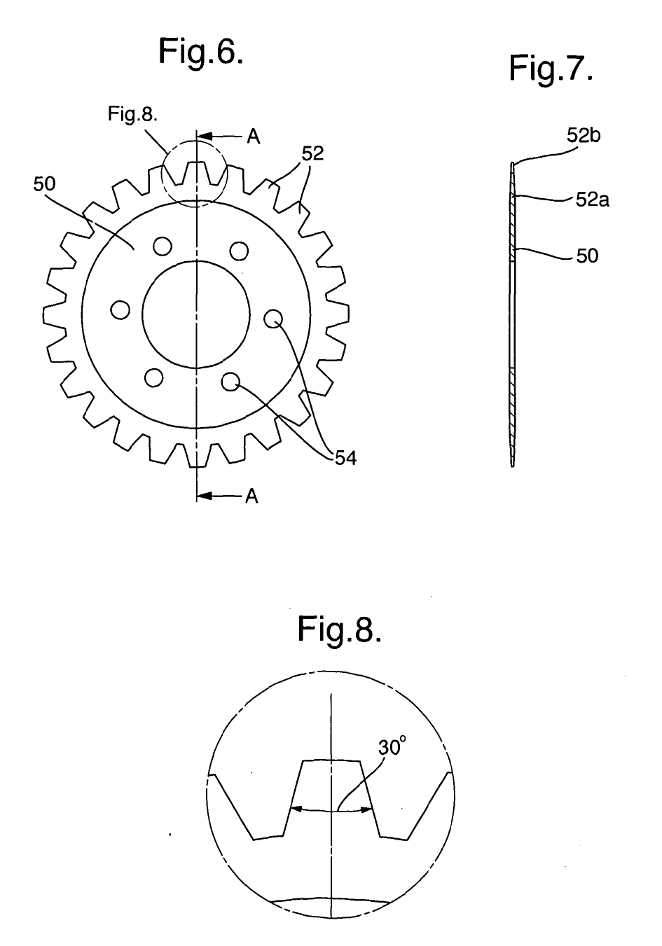

FIG. 6 is front view of an incisor disc for use in embodiments of the invention;

FIG. 7 is a cross-section of the incisor disc of FIG. 6 along line A-A;

FIG. 8 is a close-up view of a tooth of the incisor disc of FIG. 6;

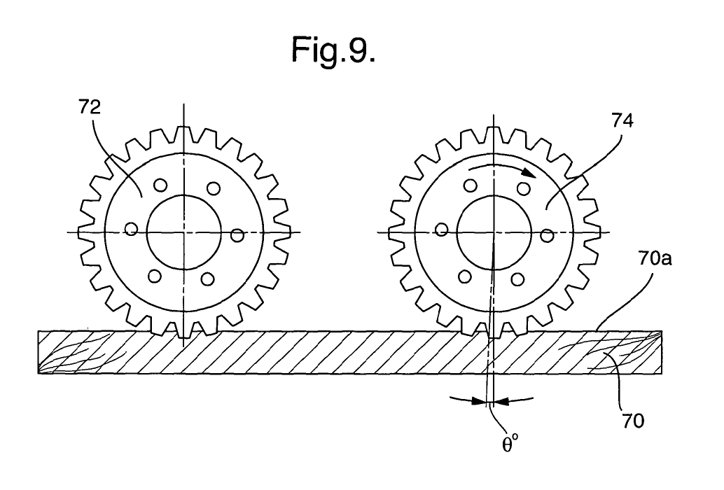

FIG. 9 is a schematic diagram of two adjustable rollers embodying the invention, and a plank of wood

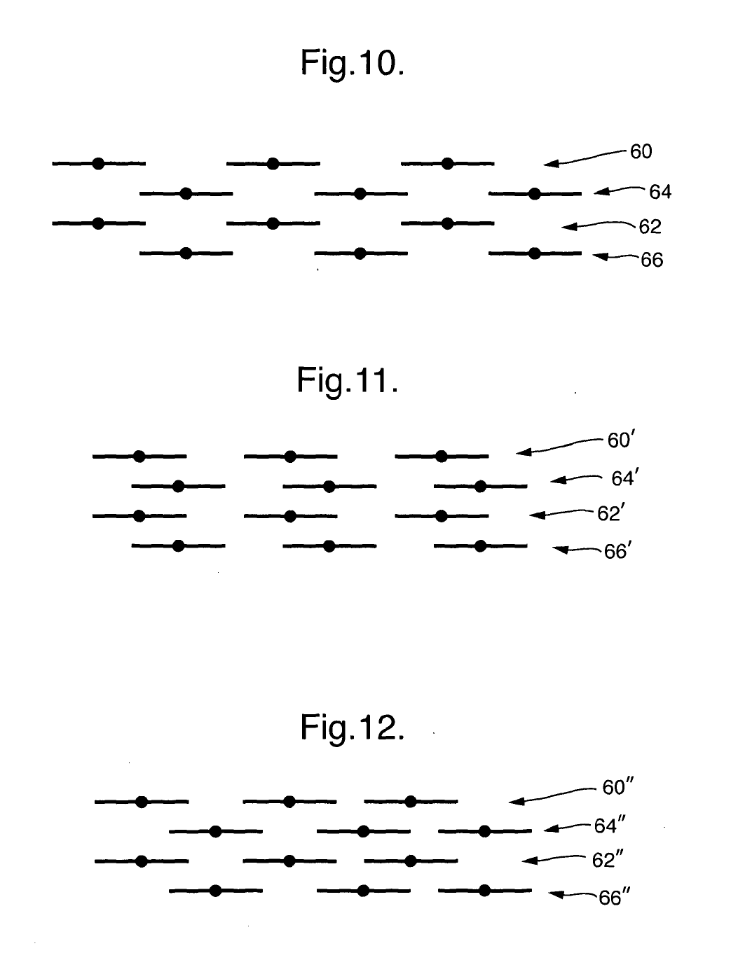

FIG. 10 is a schematic plan diagram of a pattern of incisions formed by an apparatus embodying the invention, illustrating a principle of the invention;

FIG. 11 is a schematic plan diagram of a pattern of incisions formed by a prior art apparatus, illustrating a principle of the invention;

FIG. 12 is a schematic plan diagram of a pattern of incisions formed by an apparatus embodying the invention, illustrating a principle of the invention;

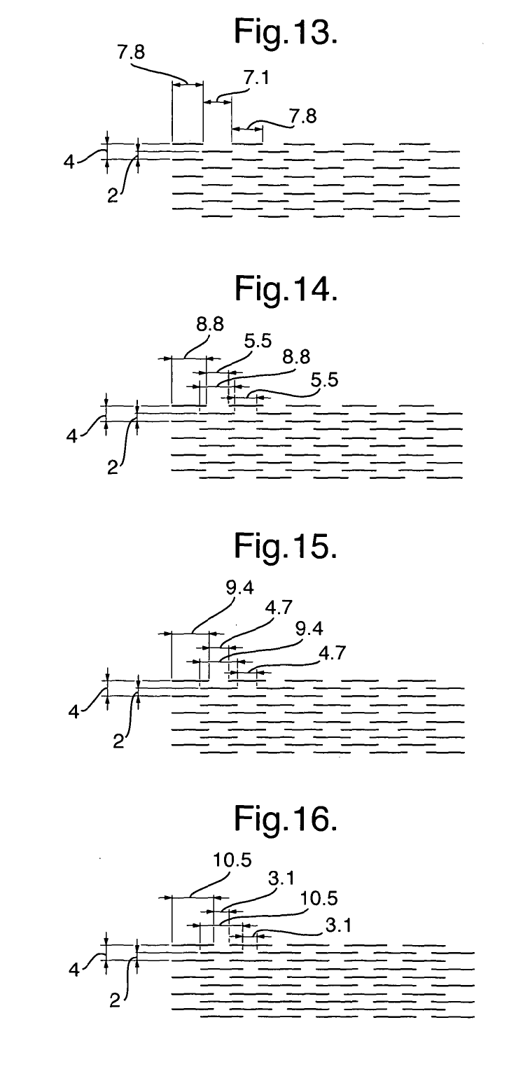

FIG. 13 is a plan diagram of a first pattern of incisions in a plank formed by an apparatus embodying the invention;

FIG. 14 is a plan diagram of a second pattern of incisions in a plank formed by an apparatus embodying the invention;

FIG. 15 is a plan diagram of a third pattern of incisions in a plank formed by an apparatus embodying the invention;

FIG. 16 is a plan diagram of a fourth pattern of incisions in a plank formed by an apparatus embodying the invention;

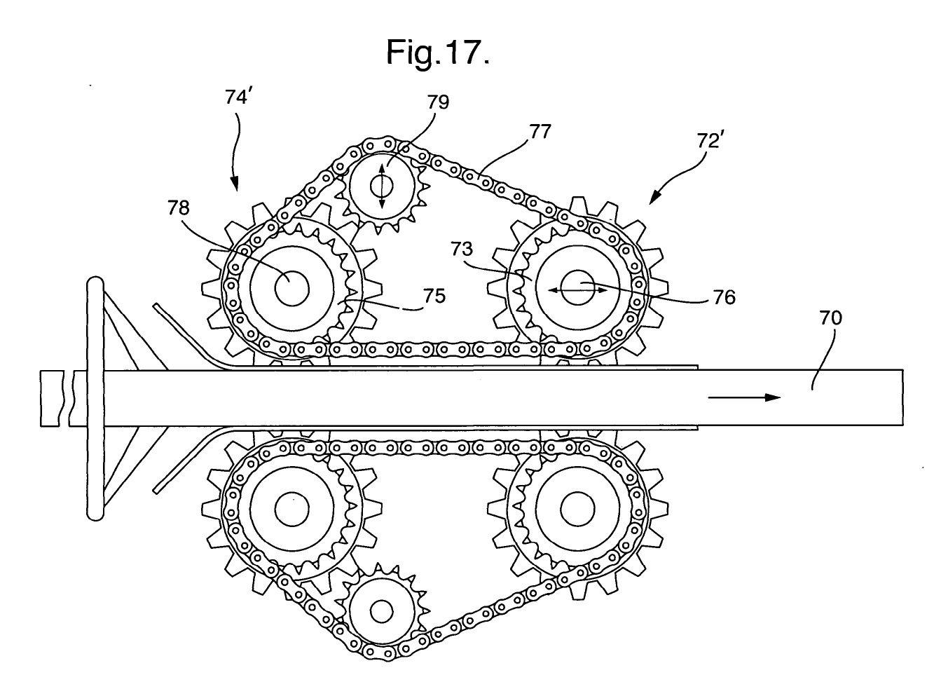

FIG. 17 is a schematic side view showing certain primary components of another apparatus embodying the invention;

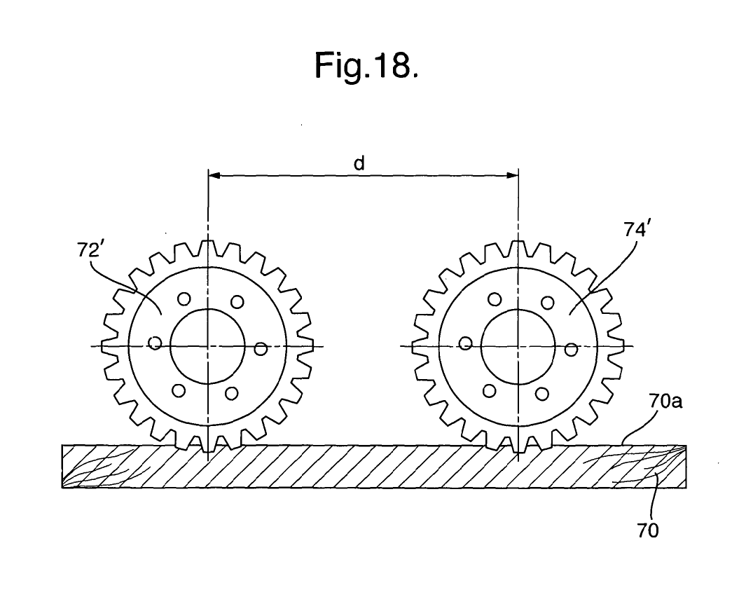

FIG. 18 is a schematic diagram of two rollers from the apparatus of FIG. 17 and a plank of wood;

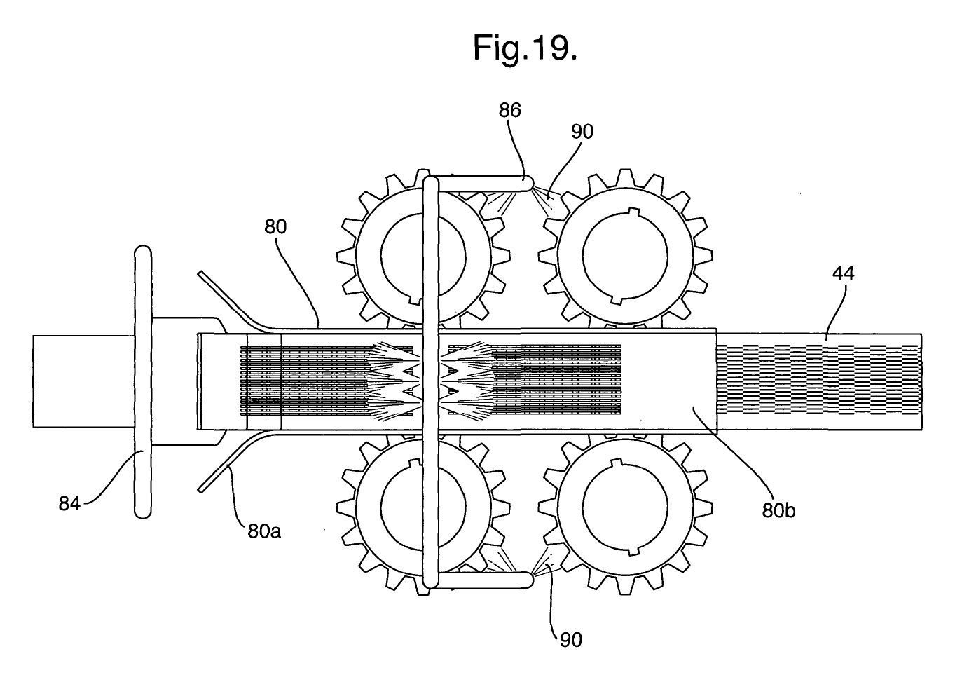

FIG. 19 is plan view of certain parts of the apparatus; and

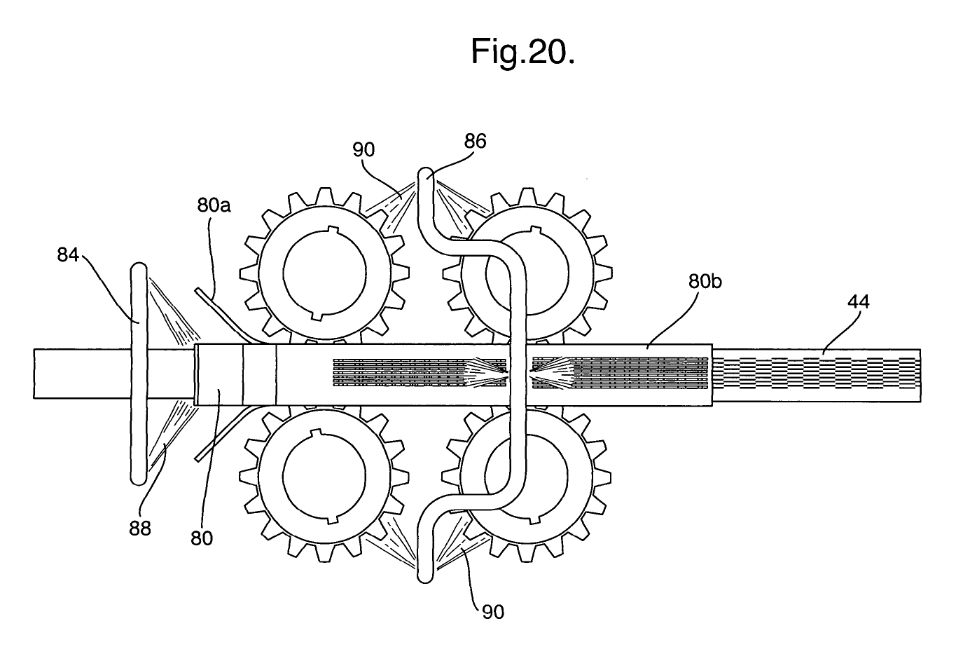

FIG. 20 is a side view of the apparatus of FIG. 19.

FIG. 1 shows an exploded view of the main components of an apparatus embodying the invention. It comprises a framework 2 to which the various other components are attached. The framework 2 is protected by a cover 4 which provides a lid and substantially surrounds the four side faces of the apparatus. Inside the cover 4, and attached to the framework 2, are four pairs of incising rollers: a set of two horizontal pairs of rollers 6 arranged to act on respective horizontal faces of an inserted plank (not shown), and a set of two vertical pairs of rollers 8 arranged to act on respective vertical faces of the plank.

The upper horizontal pair comprises an upper leading roller 10A and an upper trailing roller 12A; similarly the lower horizontal pair comprises a lower leading roller 10B and a lower trailing roller 12B, while the left and right vertical pairs (as viewed looking in through entrance port 18) respectively comprise left and right leading rollers 10C, 10D, and left and right trailing rollers 12C, 12D.

The lower and left pairs of rollers 10B, 10C, 12B, 12D are secured in a fixed position within the framework 2, while the upper and right pairs 10A, 10D, 12A, 12D are secured temporarily against notched racks 14, 16 within the framework 12. The notches allow the position of the upper and right pairs to be adjusted to alter the spacing between the pairs of rollers of each set of rollers 6, 8.

The framework 2 and cover 4 cooperate to define a rectangular entrance port 18 and a rectangular exit port 19. A plank of wood can be inserted through the entrance port 18, passing between the pairs of horizontal rollers 6, then between the pairs of vertical rollers 8, before leaving the apparatus through the exit port 19.

FIG. 2 shows the upper pair of rollers in more detail, along with a leading cleaning comb 20 and a trailing cleaning comb 22. The leading roller 10A and trailing roller 12A are identical to one another, but are held between a left mount 24 and a right mount 26 such that the leading roller 10A is close to the entrance port 18 and the trailing roller 12A is close to the exit port 19. The leading roller 10A comprises a cylindrical axle which engages with the left and right mounts 24, 26, and which holds an left annular guide disc 30, an array of coaxial, annular incising discs 32 arranged along a part of its length, and a right annular guide disc 34, the guide discs sandwiching the array of incising discs 32. The axle 28 has two elongate splines (not visible) along its length, which engage in corresponding notches in the incising discs to hold them in fixed rotational alignment with the axle. Spacer rings 36 are fitted to the remainder of the axle 28 between the right guide disc 34 and the right mount 26. The trailing roller 12A is arranged similarly to the leading roller 10A.

The apparatus illustrated in FIGS. 1 to 3 has separate motors 38, 39 fixed to the right mount 26 driving the incisor rollers 10A, 12A of the upper pair respectively. Further motors operate the other rollers. Each of these can take the form of a servo-motor and have a position encoder associated with it. This allows the two rollers of each pair to be driven synchronously at a predetermined rotational offset.

The upper leading cleaning comb 20 comprises a rod 41 of square cross-section which carries an array of cleaning prongs 43 along part of its length. The rod 41 is secured through square holes in the framework 2 so as not to rotate. It is positioned by the framework 2 such that each prong 43 extends upwardly into a gap between a respective pair of incising discs in the upper leading roller 10A (FIG. 2 is an exploded view and does not show this relationship).

The upper trailing cleaning comb 22 is identical to the leading cleaning comb 20, but is installed with its cleaning prongs arranged to point downwardly between the incising discs of the trailing roller 12A.

FIG. 3 shows the lower pair of rollers 10B, 12B and their associated cleaning combs 45, 47. The rollers are identical to those of the upper pair. The lower cleaning combs 45, 47 are mirror images of the upper cleaning combs 20, 22, the lower leading cleaning comb 45 having its prongs angled downwardly, and the lower trailing cleaning comb 47 having its prongs angled upwardly. This difference is due to the opposite direct of rotation of the lower rollers from the upper rollers.

In use, the cleaning combs scrape wood dust and debris away from the incising discs, so that the incising action of the discs is not impaired by an accumulation of waste material.

FIG. 4 shows schematically the action of the upper pair of roller 10A. The roller axle (not shown) is driven by the motor 38 so as to turn the array of incising discs 32 in the direction indicated by the arrows on the foremost incising disc 40. Only four incising discs are shown here; however the apparatus would typically have more discs per roller than this. Each disc here has fifteen teeth 42 projecting radially-outwardly, spaced around its circumference. The teeth engaging periodically in the upper face of a wooden plank 44, which is propelled in the direction indicated by the arrow by the action of the rollers. The teeth bite into the wood, separating and compressing fibres in the wood to leave regular elongate incisions 46 in the wood. In this example, the teeth 42 in the incising discs are rotationally aligned across all the discs, so a rectangular grid of incisions 46 is left in the wood. Other patterns are also possible, as explained in more detail below.

FIG. 5 shows the effect of both upper rollers 10A, 12A on the plank 44. The incising discs 32 of the leading roller 10A create a first pattern of incisions 46 in the plank. A short while later, the part of the plank incised by the leading roller 10A is engaged by the incising discs of the trailing roller 12A. However, the incising discs of the trailing roller 12A are axially offset relative to those of the leading roller 10A by a distance equal to half the spacing between adjacent incising discs on the rollers. Thus the trailing roller 12A lays down a pattern of incisions 48 that interleaves with the pattern from the leading roller 10A. In this way, the resulting pattern of incisions in the plank 44 has a narrower spacing across the width of the plank than is achievable by either of the rollers acting alone. The interleaved patterns are also longitudinally offset by half the repetition length which gives an overall even pattern of incisions.

FIG. 6 shows a single, flat incising disc 50 from another embodiment of the invention. The disc 50 has twenty-four teeth 52 spaced evenly around its circumference and is approximately 60 mm in diameter, excluding the teeth. Within the plane of the disc the teeth do not taper to a point, but have a blunt circumferential edge.

The incising disc 50 has six through-holes 54 spaced in a coaxial ring of approximately half the diameter of the whole disc 50, which can be used to secure it to a plate located on an axle of a roller; this is an alternative securing mechanism to that shown in the embodiment above.

FIG. 7 shows a cross-section of the disc 50 along a diameter A-A. It illustrates how the teeth 52 reduce in thickness from around 1.6 mm where they join the disc 52a, to approximately 0.5 mm thick towards their radially-extreme edge 52b.

FIG. 8 shows a close-up view of one tooth 52. The leading and trailing edges of the tooth are inclined at approximately 30 degrees to each other, narrowing with increasing radial distance until they reach the circumferential tooth edge.

FIG. 9 shows, in side view, two incising discs 72, 74 in the process of incising a plank 70. The teeth of the discs are embedded below the surface 70a of the plank 70. It shows how the rotational position of one of the discs 74 may be altered using the servo-motor by an angle, theta, relative to the other disc 72, in order to compensate for variations in the depth to which the teeth are embedded, as will be explained below.

FIGS. 10 to 12 illustrate the principle of adjusting the incisors to compensate for the variation in incision depth in accordance with the present invention. FIG. 10 shows a combined pattern of incisions formed by a pair of rollers in the manner previously described. Thus a first incisor disc of a first roller forms a first row of evenly-spaced incisions 60, while a second incisor disc of the first roller forms a second row of evenly-spaced incisions 62, of the same dimensions as those of the first row, and laterally aligned with it. Two further rows of incisions 64, 66 are formed by first and second discs of a second roller. In this instance, these incisions are of the same dimensions as those of the first roller, but are interleaved such that the mid-points (indicated by dots) of the incisions from the second roller are longitudinally positioned half way between longitudinally-adjacent mid-points of incisions formed by the first roller. Since the spatial repetition period of the combined pattern here is the length of one incision plus one the length of one gap until the next incision, the longitudinal alignment between the patterns formed by the two rollers, expressed as a fraction, is 50%. Thought of another way the two patterns are 180 degrees out of phase.

FIG. 11 shows what would happen if the incision depth were simply increased by lowering the incisors slightly to drive the teeth more deeply into the plank. Due to the angled shape of the teeth, the length of each incision is increased. Also, the mid-points of the incisions in each row are brought closer together due to the distance between the axle and the surface of the plank being reduced and so the effective circumference of rotation being reduced. This means that the longitudinal alignment between the pattern of incisions 60′, 62′ formed by the first roller and those 64′, 66′ formed by the second roller is changed—the phase difference is about 90 degrees rather than 180 degrees. This means that the incisions of the combined pattern are not distributed as evenly across the surface of the plank, which may result in preservative failing adequately to reach all parts of the wood sub-surface.

FIG. 12 shows how this is improved when compensation is applied in accordance with the invention—e.g. by altering the angle of one of the incisor rollers as shown in FIG. 9. The incisions are still longer and closer-together longitudinally than when operating at the shallower penetration depth shown in FIG. 10. However, the longitudinal alignment between the rows 60″, 62″ of incisions formed by the first roller and those 64″, 66″ formed by the second roller is maintained in anti-phase despite the increase in depth.

FIGS. 13 to 16 illustrate combined incisions patterns at increasing penetration depth generated by apparatus of the present invention. The synchronisation or longitudinal of the component patterns is preserved across all the depths.

FIG. 17 shows part of another apparatus embodying the invention. In this embodiment the separation between a leading, upper incising roller 74′ and a trailing, upper incising roller 72′ can be changed to compensate for changes in the desired incision depth when incising a plank 70, moving in the direction indicated by the arrow. Each roller has an axial shaft 76, 78, to the proximal end of which is attached a respective sprocket 73, 75. A chain 77 passes around the two sprockets and around a tensioning sprocket 79, in an approximately triangular path. The shaft 78 of the leading incising roller 74′ is fixed permanently to a mounting frame (not shown). The shaft 76 of the trailing incising roller 72′, however, is secured to a slidable chassis (not shown), which permits it to move laterally towards and away from the trailing incising roller 74′, as indicated by the arrow.

The tensioning sprocket 79 is also slidably movable, in order to take up or release any slack in the chain 77 when the trailing incising roller 72′ is adjusted.

An identical, inverted arrangement of rollers, chain and tensioning sprocket acts on the opposite face of the plank 70. Additional, similar arrangements may be provided to act on the other faces of the plank.

FIG. 18 shows the operation of this adjustment mechanism schematically. The distance, d, between the axes of the two incising discs 72′, 74′ may be varied by the chain mechanism so as to compensate for variations in the depth to which the teeth are embedded.

FIGS. 19 and 20 show plan and side views an arrangement in which respective pairs of rollers are acting on each face of a plank 44 as previously described. A guide 80 takes the form of a tube through which the plank 44 passes. The guide 80 may be formed of metal. A flared opening section 80a guides the plank 44 into a trunk 80b having a cross-section conforming closely to that of the plank 44 so as to provide a snug fit around a perimeter of the plank 44.

Slots through the faces of the guide 80 are aligned with respective incising discs, one slot for each disc. These slots allow the teeth of the incising discs to penetrate the plank 44 unimpeded; however, they are dimensioned such that the guide 80 comprises strips of material in contact with the surface of the plank 44 between each adjacent pair of slots. These strips resist tearing and splintering of the plank 44 as the teeth leave the wood by providing an opposite force on the wood where necessary. The guide 80 may be used in addition to or instead of the combs described previously.

Also shown are two spray bars which surround the plank 44: a plank spray bar 84 and a roller spray bar 86. The plank spray bar 84 is arranged to spray a liquid lubricant 88, such as water or diluted sap-stain product, onto the surface of the plank 44 as it passes. The roller spray bar 86 is arranged to spray a liquid lubricant 90, which may be the same as or different from that sprayed by the plank spray bar 84, onto the incising rollers. This lubrication aids the incising process.

1. Apparatus for forming incisions in a timber plank, comprising:
at least two rotary incisors each comprising a plurality of circumferentially distributed teeth and arranged in use to rotate at the same rate to form respective patterns of incisions in a common face of a plank as it is moved past the incisors, said patterns having a predetermined longitudinal alignment between them;
depth-controlling means arranged to maintain, for each incisor, a predetermined depth of penetration of the teeth thereof into the plank;
means for adjusting said predetermined depths of penetration; and
means for allowing adjustment of the incisors to compensate for the altered spatial period in said patterns when the depths of penetration of the incisors are adjusted, thereby allowing said longitudinal alignment between the respective patterns to be maintained.

2. Apparatus as claimed in claim 1 wherein the same regular pattern of teeth is provided on each incisor.

3. Apparatus as claimed in claim 1 wherein each of the patterns has a longitudinal spatial repetition period which is either equal to, or is an integer fraction of, the spatial period.

4. Apparatus as claimed in claim 1 wherein for each incisor the teeth at any given axial distance along the incisor are uniformly distributed around the circumference.

5. Apparatus as claimed in claim 1 wherein the compensating means comprises means for adjusting the distance between the axes of the two rotary incisors.

6. Apparatus as claimed in claim 5 wherein one of the incisors can be slidably moved towards and away from the other incisor.

7. Apparatus as claimed in claim 6 wherein one incisor is fixed relative to a housing or frame and the other incisor is movable.

8. Apparatus as claimed in claim 1 wherein the means for compensating comprises means for adjusting the rotational offset of the teeth of one of the incisors relative to the teeth of the other incisor.

9. Apparatus as claimed in claim 1 wherein each of the incisors comprises a plurality of coaxial, toothed incisor discs.

10. Apparatus as claimed in claim 9 wherein the discs are, except for the teeth, substantially circular or annular.

11. Apparatus as claimed in claim 9 wherein the discs are fixed to an axle or shaft.

12. Apparatus as claimed in claim 9 wherein every incisor disc is the same.

13. Apparatus as claimed in claim 1 wherein the depth-controlling means comprises a guide acting on one of the faces of the plank.

14. Apparatus as claimed in claim 13 wherein said guide is adapted to control the depth relative to the face being incised.

15. Apparatus as claimed in claim 13 comprising a fixed, but adjustable, spacing between the guide and the toothed incisors.

16. Apparatus as claimed in claim 1 wherein the depth-controlling means comprises one or more further incisors, acting on a parallel opposed face.

17. Apparatus as claimed in claim 16 wherein the depth-controlling means comprises means for holding the two pairs of incisors at a fixed separation distance from each other.

18. Apparatus as claimed in claim 1 comprising four pairs of incisors, each pair arranged to act on a different face of a plank of rectangular cross section.

19. Apparatus as claimed in claim 18 comprising depth-controlling means, depth-adjusting means and compensation means in respect of every pair of incisors.

20. Apparatus as claimed in claim 1 wherein at least one incisor of the apparatus is powered so as to propel the plank through the apparatus.

21. Apparatus as claimed in claim 20 wherein at least one incisor of every set of incisors acting on respective common faces of the plank is driven.

22. Apparatus as claimed in claim 1 wherein all the incisors acting on a common face of the plank are synchronised so that the regular patterns of incisions from each incisor interleaves those of the other incisors in a predetermined manner to yield a desired final pattern.

23. Apparatus as claimed in claim 1 comprising a timing belt or chain connecting between sprockets or wheels mounted on, or communicating drive to, an axle of each incisor.

24. Apparatus as claimed in claim 23 wherein comprising tensioning means acting on the chain or belt to maintain a desired tension when the distance between two or more incisors is increased or decreased.

25. Apparatus as claimed in claim 23 comprising tensioning means configured to enable the belt or chain to be slackened sufficiently that the rotational and/or lateral position of one or more of the incisors may be changed by disengaging the belt or chain from the respective incisor, rotating and/or laterally moving the incisor, and re-engaging the chain with the incisor.

26. Apparatus as claimed in claim 24 configured to allow compensation to be applied to two incisors for the altered period of the pattern of incision by moving the tensioner relative to one or both incisors so as to alter the length of a section of chain or belt extending directly between the respective incisors, thereby simultaneously altering the separation distance between the incisors and the relative rotational offset between the incisors.

27. Apparatus as claimed in claim 1 wherein the incisors are each directly driven and comprising means to ensure that the rotation of the drive incisors is synchronised at the same rate as each other.

28. Apparatus as claimed in claim 1 wherein the teeth of the incisors are each symmetrical about a central radial line.

29. Apparatus as claimed in claim 1 wherein the teeth of the incisors are three-sided, tapering in width towards their distal edges.

30. Apparatus as claimed in claim 1 wherein the teeth of the incisors taper in thickness towards their tips but not to a knife-edge.

31. Apparatus as claimed in claim 1 wherein each incisor disc carries between 1 and 100, or between 20 to 30 teeth.

32. Apparatus as claimed in claim 1 comprising a mechanism for removing debris from the incisor discs and/or for preventing ripping of the timber surface.

33. Apparatus as claimed in claim 1 comprising a guide having one or more through slots arranged such that the slots are aligned with respective incisor discs so as to form pressure plates between adjacent discs.

34. Apparatus as claimed in claim 1 comprising means for lubricating the plank as it passes through the apparatus.

35. Apparatus as claimed in claim 34 comprising a nozzle for spraying a liquid lubricant or wetting agent onto some or all of the plank.

36. A method of operating a machine for forming incisions in a timber plank, comprising:
using at least two rotary incisors each comprising a plurality of circumferentially distributed teeth and rotating at the same rate to form respective patterns of incisions at a first incision depth in a common face of the plank as it is moved past the incisors, said patterns having a predetermined longitudinal alignment between them;
adjusting said machine to form said respective patterns of incisions at a second, different incision depth; and
adjusting said incisors to compensate for the altered spatial period in said patterns, thereby maintaining said longitudinal alignment between the respective patterns.

37. A method as claimed in claim 36 wherein said step of adjusting said incisors to compensate for the altered spatial period in said patterns comprises moving one of the incisors of the pair towards or away from the other incisor.

38. A method as claimed in claim 36 wherein said step of adjusting said incisors to compensate for the altered spatial period in said patterns comprises changing the rotational position of one or the incisors relative to the other incisor.

39. An apparatus for forming incisions in a timber plank, comprising:
a frame;
first and second rotary incisors mounted on respective axles held by said frame, each incisor comprising a plurality of circumferentially distributed teeth and arranged in use to form respective patterns of incisions in a common face of a plank as it is moved past the incisors;
depth-controlling means arranged to maintain, for each incisor, a predetermined depth of penetration of the teeth thereof into the plank; and
means for adjusting said predetermined depths of penetration,
wherein the frame defines a plurality of positions at which the axle of the second incisor may be held, each position corresponding to a different separation distance between the second axle and first axle.

40. (canceled)
